(19) United States
(12) Patent Application Publication
(10) Pub. No.: US 2008/0071862 A1
(43) Pub. Date: Mar. 20, 2008

(54) DYNAMIC DIRECTORY GROUP CREATION VIA ELECTRONIC EVENT SCHEDULING

(75) Inventor: Joshua D. Burchard, Cambridge, MA (US)

Correspondence Address: CANTOR COLBURN LLP - IBM LOTUS, 20 Church Street, 22nd Floor, Hartford, CT, 06103, US

(73) Assignee: International Business Machines Corporation, Armonk, NY (US)

(21) Appl. No.: 11/532,318

(22) Filed: Sep. 15, 2006

(51) Int. Cl. G06F 15/16

(52) U.S. Cl. 709/204; 709/206

(57) ABSTRACT

A computer program product is described and provides for dynamically creating and providing a group to an application, by identifying a list of individuals to provide as the group; providing a name for the group; automatically saving the group; and automatically deleting the group after a predetermined period of time.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to collaboration with relation to management of groups and particularly to dynamic creation of groups.

2. Description of the Related Art

In the current, fast-paced world of e-mail, instant messaging and various other incarnations of electronic collaboration, it's more important than ever to be able to communicate efficiently and effectively with one's peers.

It's particularly difficult to be efficient in the case of temporary collections (i.e., groups) of people. Take the example of attendees to an electronically orchestrated meeting or other event. The meeting coordinator may need to communicate with the group for some undetermined period of time before and after the event has occurred.

Communication with the group of meeting invitees can be accomplished today through the cumbersome means of copying all the names on an invitee list and either pasting them into an e-mail, or somehow or another importing them into any of a multitude of collaborative software applications. To reiterate though, this method is inefficient and overly burdensome to the person generating the communication.

In many instances, selection of groups is an inaccurate or tedious process. Consider use of an email client. In the case where an email client makes use of groups, one may wish to email an entire group. However, if an individual wishes to send email to selected individuals from various groups, the options are limited. One solution calls for selecting the various groups and sending the email to an excessively broad audience. This can be annoying both to the recipients as well as the sender.

Another solution is to specify the recipients (who are members of various groups) by hand. Manual specification involves looking up the members and filtering the list as appropriate. Basically, this approach requires the manual resolution of group members, manual member filtration, and manual member entry, which is both time-consuming and tedious.

What are needed are techniques for simplifying the selection of groups that contain a better approximation of the list of members needed. Preferably, the techniques provide for minimal user input and therefore rapid task completion.

### SUMMARY OF THE INVENTION

The shortcomings of the prior art are overcome and additional advantages are provided through the provision of a computer program product stored on machine readable media for executing machine readable instructions to provide a group including a listing to an application, the instructions providing for: identifying a list of individuals to provide as the group; providing a name for the group; automatically saving the group; and automatically deleting the group after a predetermined period of time.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product stored on machine readable media including one of a server and a workstation, the product for executing machine readable instructions to provide a group including a listing to one of an email client, an access control application and a messaging application, provides instructions for, over a network: identifying a list of individuals to provide as the group; providing a name for the group; automatically saving the group by storing the group in a data directory; automatically deleting the group after a predetermined period of time selected by a user; and providing an event tracker for manually modifying the group by at least one of adding and deleting members from the group as well as opening a meeting.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 illustrates aspects of an exemplary user interface where an on-line meeting might be scheduled;

FIG. 3 illustrates aspects of an application adapted for dynamically creating a group;

FIG. 4 depicts aspects of an exemplary use of the group;

FIG. 5 depicts an exemplary interface for an event tracker that allows for modification of the dynamically-created group's member list;

FIG. 6 depicts aspects of another exemplary use of the group after modification in FIG. 5; and,

FIG. 7 depicts an exemplary method for dynamically creating the group.

The detailed description explains the preferred embodiments of the invention, together with advantages and features, by way of example with reference to the drawings.

### DETAILED DESCRIPTION OF THE INVENTION

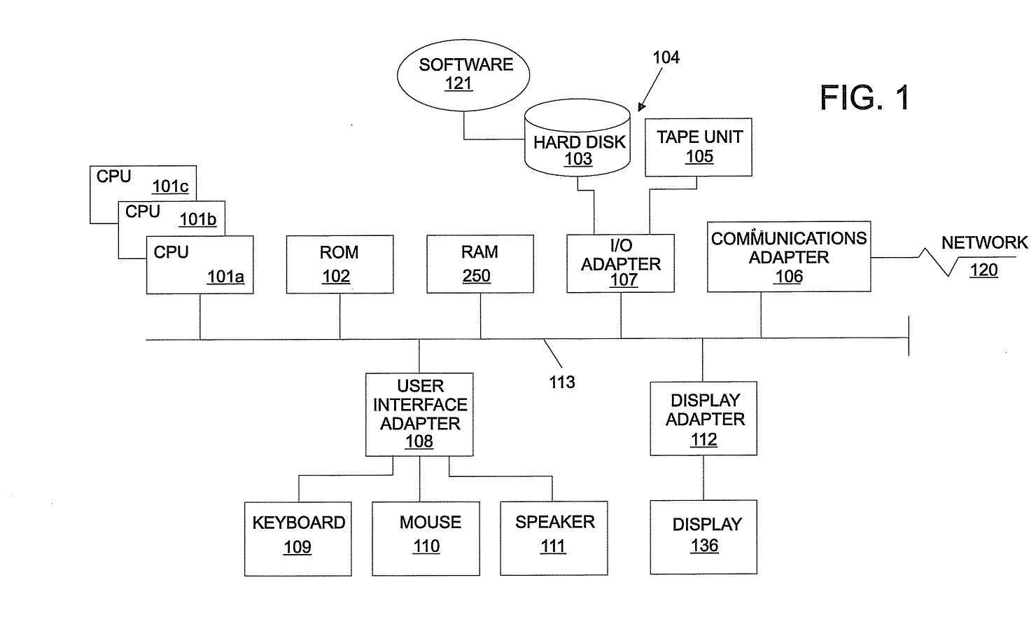

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for providing for dynamic groups. As referred to herein, the instructions are referred to as dynamic grouping software 121. The software 121 may be produced using software development tools as are known in the art.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

The creation of dynamic groups allows for the quick, temporary, enduring or permanent specification of a group. In typical embodiments, the software 121 integrates with another application, such as one of a meeting creation application and an event scheduling application. The software 121 provides functionality for dynamically creating a group from a list (e.g., of attendees) and stores the group for future use. This dynamically created group will provide an easy, efficient solution to the problem of staying in contact with a list of attendees.

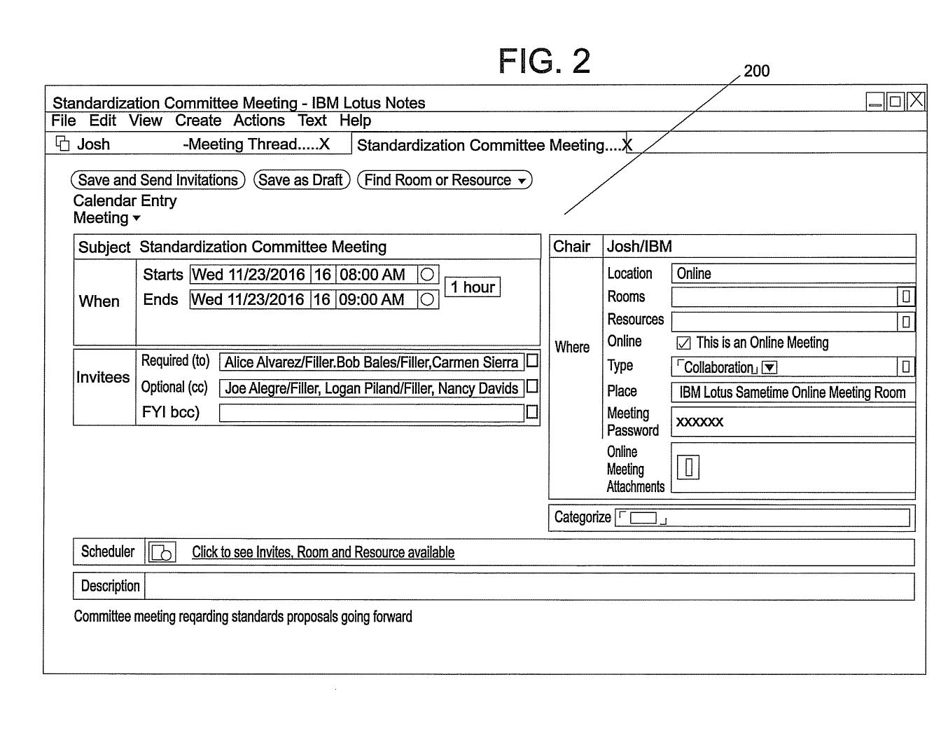

An exemplary embodiment of the software 121 is provided, using Lotus Notes from IBM Corporation as the exemplary application. Reference may be had to FIG. 2.

In FIG. 2, an application user interface 200 is provided. The user interface 200 provides a facility for scheduling an event. In this example, the event is an on-line meeting.

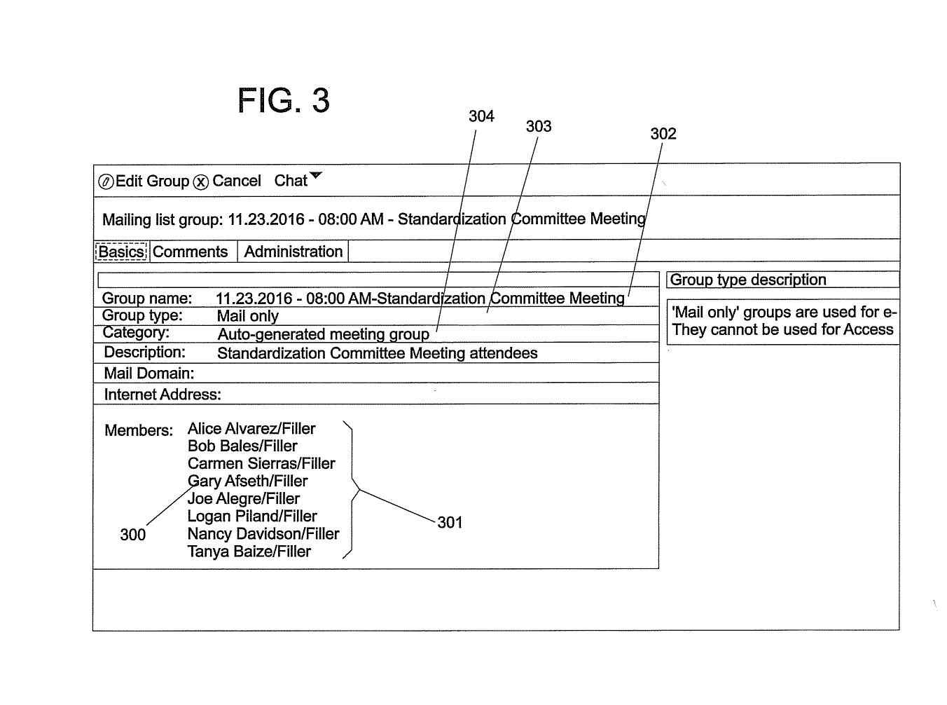

With reference to FIG. 3, a list 301 of group members is provided and forms a group 300. In some embodiments, the user interface 200 includes a naming facility 302 for naming of the group. Typically, the group 300 is provided with a default name, such as one associated with a title of the email (and may include the date and time). Storing of the group may involve use of local storage 104, storage reachable via the network 120 and may occur by storing in RAM 250.

The group 300 is typically stored (i.e., saved) automatically. That is, the user need not make an affirmative action to save the group 300. In typical embodiments, once the group is named, the group is stored (for example, upon an exit or a transmission).

The group 300 may be further identified and characterized by features such as a group type 303 and a group category 304. Each of the group type 303 and the group category 304 may be customized as desired. For example, one of manual and auto-fill text may be used to complete fields for the group type 303 and group category 304.

Typically, the group 300 is stored as a personal group for each user of the application. That is, the user that creates the group 300 has sole access to the stored group 300 as a part of, for example, a personal address book.

In this embodiment, upon completing generation of the list 301 of people relevant to the meeting, then saving and sending the invitation, a Notes/Domino Group is dynamically created in a Notes Personal Address Book that has the meeting subject as its default name, and the list 301 as members of the group 300.

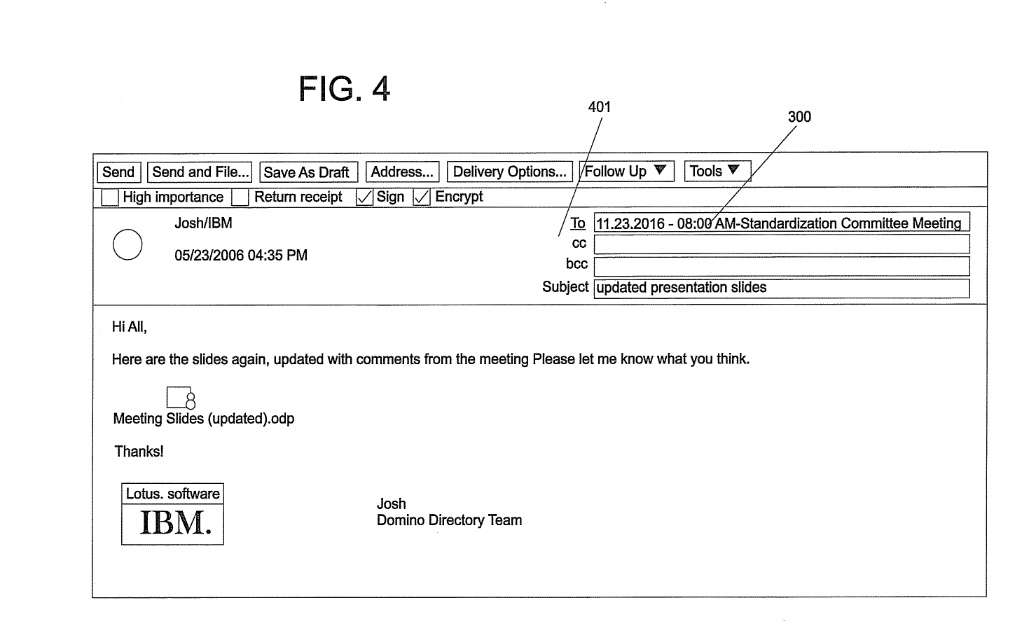

In FIG. 4, the user makes use of the group 300 as would typically occur with a prior art group. For example, consider that a month after the meeting has taken place, the user (as meeting chairman) finds some slides of interest for sharing with the group 300. In this embodiment, the user simply identifies the dynamically created group 300 for distribution of the slides. An email 401 is sent making use of the group 300 previously created in FIG. 4.

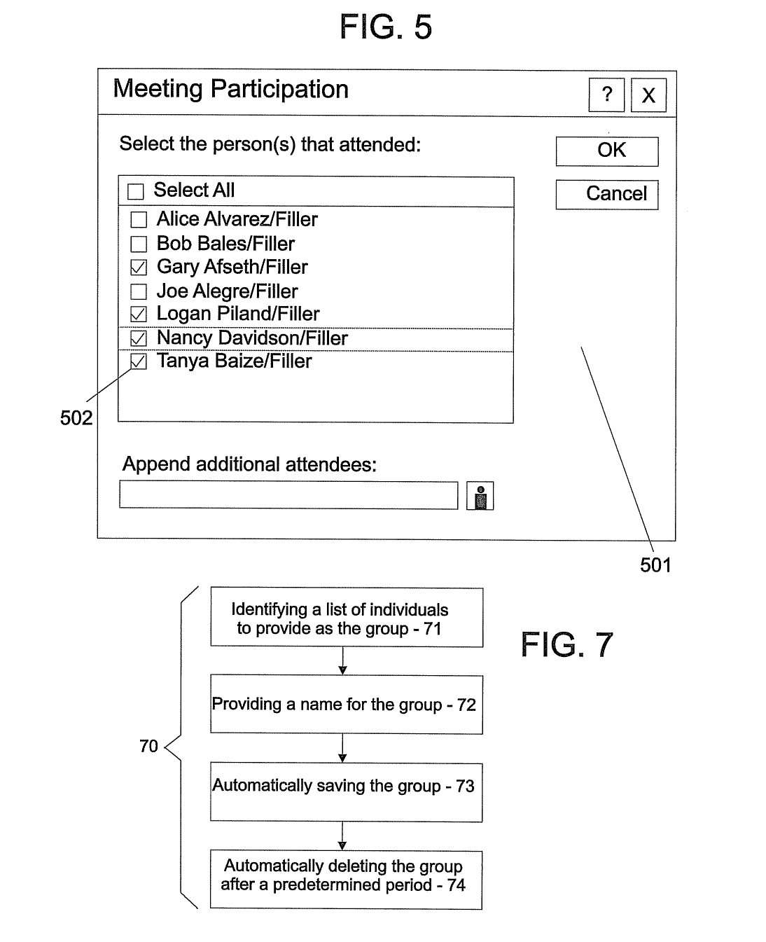

Further uses of dynamically created groups 300 may be had. For example, with reference to FIG. 5, while the meeting is being held, an event tracker 501 may be included with the software 121. An example of the event tracker 501 permits an event chairman to record actual attendance by having the application display a dialog box containing the names relevant to the meeting. In some embodiments, the event tracker 501 provides for opening the meeting (such as where the meeting is an on-line meeting). In this example, a checkbox 502 appears next to each name for selection or de-selection of group members. A dialog box is provided as a member identifier field 503. The dialog box is included to provide for adding names to the list 301 for people who attended the meeting but who didn't receive an invitation.

In some embodiments using the event tracker 501, the dynamically created group 300 inherits changes initiated from the dialog box. In some other embodiments using the event tracker 501, the dynamically created group 300 does not inherit changes initiated from the dialog box. In further embodiments, properties of the dialog box are set elsewhere in the software 121.

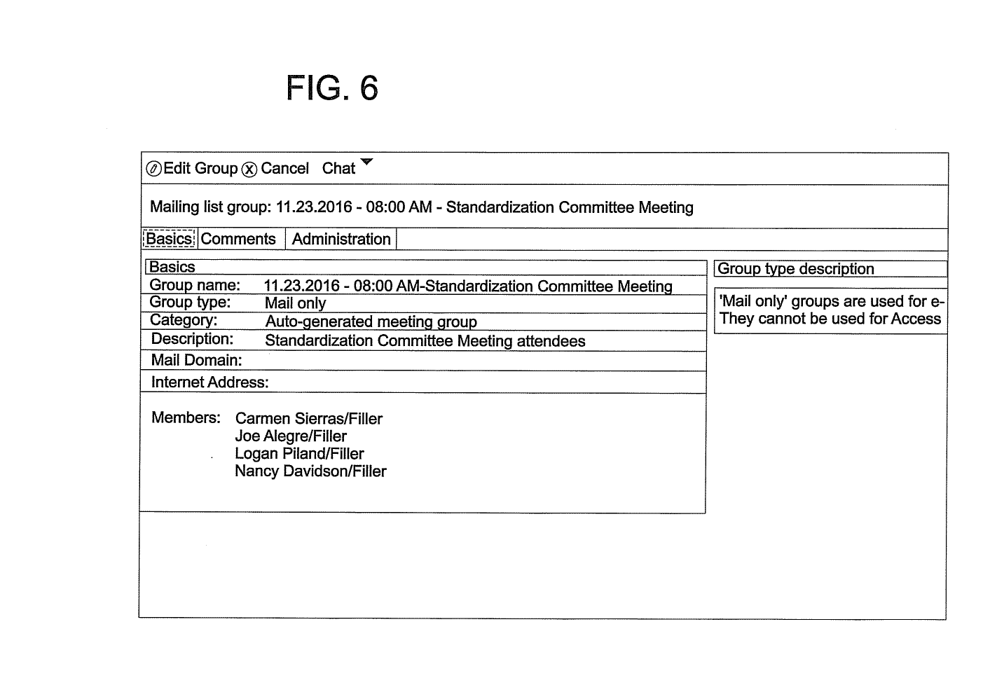

In FIG. 6, another exemplary use of the group 300 is provided. FIG. 7 depicts aspects of an exemplary method for dynamically creating the group 300.

In FIG. 7, the method for creating the group 70 provides for identifying a list of individuals to provide as the group 71, providing a name for the group 72, automatically saving the group 73 and automatically deleting the group after a predetermined period of time 74.

In some embodiments, the dynamically created groups 300 expires after a predetermined period of time. In some other embodiments, the dynamically created groups 300 endure until manual deletion or manual archiving takes place.

Various embodiments of the software 121 use time-stamping in order to allow the “administrator” (an entity with the proper permission level) to modify the dynamic group 300 and cause the group 300 to expire on a certain date and time. Typically, the dynamically created group 300 is maintained inside of a directory store, and the group 300 is as mutable as any other directory entry. Further, the group 300 that the members of the group 300 can be added or removed at will.

The dynamically created group 300 formalizes the collection of people participating in some event and creates a group entity that typically resides in a directory data store. The group 300 can be used or modified at will.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media for executing machine readable instructions to provide a group comprising a listing to an application, the instructions comprising instructions for:
identifying a list of individuals to provide as the group;
providing a name for the group;
automatically saving the group; and
automatically deleting the group after a predetermined period of time.

2. The computer program product as in claim 1, wherein the application comprises one of an email client, an access control application and a messaging application.

3. The computer program product as in claim 1, wherein the predetermined period of time is selected by a user.

4. The computer program product as in claim 1, wherein saving comprises storing the group in a data directory.

5. The computer program product as in claim 1, further comprising instructions for providing an event tracker.

6. The computer program product as in claim 1, further comprising instructions for manually modifying the group.

7. The computer program product as in claim 6, wherein manually modifying comprises at least one of adding and deleting members from the group.

8. The computer program product as in claim 1, further comprising instructions for opening a meeting.

9. The computer program product as in claim 1, wherein at least a portion of the program is stored on one of a server and a workstation.

10. The computer program product as in claim 9, wherein program provides instructions over a network.

11. A computer program product stored on machine readable media comprising one of a server and a workstation, the product for executing machine readable instructions to provide a group comprising a listing to one of an email client, an access control application and a messaging application, the instructions comprising instructions for, over a network:
identifying a list of individuals to provide as the group;
providing a name for the group;
automatically saving the group by storing the group in a data directory;
automatically deleting the group after a predetermined period of time selected by a user; and
providing an event tracker for manually modifying the group by at least one of adding and deleting members from the group as well as opening a meeting.
